(19) United States
(12) Patent Application Publication
(10) Pub. No.: US 2009/0117298 A1
(43) Pub. Date: May 7, 2009

(54) INKJET RECORDING MATERIAL

(75) Inventors: Ryoichi Nakano, Fujinomiya-shi (JP); Chiyomi Takemasa, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/258,831

(22) Filed: Oct. 27, 2008

(30) Foreign Application Priority Data
Nov. 1, 2007 (JP) 2007-284925

(51) Int. Cl. B41M 5/40

(52) U.S. Cl. 428/32.37; 428/32.34

(57) ABSTRACT

The invention provides an inkjet recording material having high glossiness and favorable ink absorbency, including a support having thereon an ink receiving layer containing silica fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0.

### CROSS-REFERENCE TO RELATED APPLICATION

This application claims priority under 35USC 119 from Japanese Patent Application No. 2007-284925, the disclosure of which is incorporated by reference herein.

### BACKGROUND OF THE INVENTION

1. Field of the Invention

The present invention relates to an inkjet recording material.

2. Description of the Related Art

Accompanying recent rapid progress of the communication industry, various information processing systems have been developed, and various recording methods and devices suitable for use in these information processing systems have also been developed and are already in use. Among the recording methods above, for example, the inkjet recording process has been widely used not only in office use but also in so-called home use, because the inkjet process allows printing on various recording materials and the hardware (devices) thereof is relatively cheaper, more compact, and more silent.

In addition, accompanying the recent trend of inkjet printers toward higher resolution and accompanying the progress of the hardware (devices), a variety of media for inkjet recording has been developed, and more recently, there are some inkjet printers available that allow printing of so-called photographic-like high-quality images.

Generally properties that are required for such an inkjet recording medium include (1) high drying speed (high ink-absorbing speed), (2) favorable and uniform ink dot diameter (without ink bleeding), (3) favorable graininess, (4) high dot circularity, (5) high color density, (6) high color saturation (absence of dullness), (7) excellent light fastness, gas resistance and water resistance of printed image portions, (8) higher whiteness of recording surface, (9) favorable storage stability of the recording medium (absence of yellowing and image bleeding during long term storage), (10) deformation resistance and favorable dimensional stability (suppressed curling), (11) favorable traveling characteristics through a machine, and the like. In addition, for application as photographic glossy sheets, which are used for printing so-called photographic-like high-quality images, glossiness, surface smoothness, a texture similar to silver halide photographic papers, and the like are also demanded in addition to the properties above.

As inkjet recording media satisfying the above demands, inkjet recording materials having at least two ink receiving layers, wherein the ratio of inorganic fine particles such as vapor-phase process silica to a water-soluble resin such as polyvinyl alcohol (PVA) in the upper layer is different from that in the lower layer, are known (for example, see Japanese Patent Application Laid-Open (JP-A) Nos. 2002-36715, 2003-72229, 2004-106202, and 2005-169666).

### SUMMARY OF THE INVENTION

The present invention has been made in view of the above circumstances and provides an inkjet recording materials.

A first aspect of the present invention provides an inkjet recording material comprising a support having thereon an ink receiving layer containing silica fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0.

### DETAILED DESCRIPTION OF THE INVENTION

However, the inkjet recording materials described in the above Patent Documents are not satisfactory from the viewpoint of glossiness.

An object of the present invention is to provide an inkjet recording material having high glossiness and favorable ink absorbency.

In light of the above-mentioned situation, the inventors have made eager researches to find out that the above-mentioned problems may be solved. Thus, the invention has been made.

Accordingly, the invention attains the object by aspects and embodiments of the following items <1> to <8>:
<1>. An inkjet recording material comprising a support having thereon an ink receiving layer containing silica fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0.
<2>. The inkjet recording material of the item <1>, wherein the water-soluble resin is polyvinyl alcohol.
<3>. The inkjet recording material of the item <1> or the item <2>, wherein the ink receiving layer further comprises a cross-linking agent.
<4>. The inkjet recording material of any one of the items <1> to <3>, wherein the ink receiving layer further comprises a water-soluble aluminum compound.
<5>. The inkjet recording material of any one of the items <1> to <4>, wherein the ink receiving layer further comprises a zirconium compound.
<6>. The inkjet recording material of any one of the items <1> to <5>, wherein the ink receiving layer further comprises an organic solvent with a high boiling point.
<7>. The inkjet recording material of the item <3>, wherein the cross-linking agent is a boron compound.
<8>. The inkjet recording material of any one of the items <1> to <7>, wherein the silica fine particles are vapor-phase process silica having a specific surface area of 200 m²/g or more as determined by the BET (Brunauer, Emmett, Teller) surface area measurement method.

The inkjet recording material of the present invention is composed of a support having thereon an ink receiving layer containing inorganic fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0. The inkjet recording material combines high glossiness with favorable ink absorbency.

If the arithmetic average of the carbon/silicon mass ratio in the outermost surface is less than 2.5, glossiness is unsatisfactory. On the other hand, if the arithmetic average of the carbon/silicon mass ratio in the outermost surface is more than 7.0, ink absorbency is unsatisfactory.

If the arithmetic average of the carbon/silicon mass ratio in the region extending from the outermost surface to a depth of 5 μm in the thickness direction of the ink receiving layer is less than 0.5, the strength of the ink receiving layer is unsatisfactory. On the other hand, if the arithmetic average of the carbon/silicon mass ratio in the region extending from the outermost surface to a depth of 5 μm is more than 4.0, ink absorbency is unsatisfactory.

In the invention, from the viewpoints of glossiness and ink absorbency, it is preferable that the arithmetic average of the carbon/silicon mass ratio in the outermost surface of the ink receiving layer be from 4.0 to 7.0, and the arithmetic average of the carbon/silicon mass ratio in the region extending from the outermost surface of the ink receiving layer to a depth of 5 μm be from 2.0 to 4.0.

In the invention the arithmetic average of the carbon/silicon mass ratio refers to the abundance ratio of the carbon atoms of the water-soluble resin to the silicon atoms of the silica fine particles.

In the invention, the arithmetic average of the carbon/silicon mass ratio in the outermost surface farthest from the support of the ink receiving layer may be determined by a common procedure using an X-ray photoelectron spectroscopic apparatus (ESCA, XPS). The X-ray photoelectron spectroscopic apparatus may be a commonly used one. Specifically, measurement is carried out as follows using AXIS-HSi manufactured by Kratos Analytical Ltd.

Using monochromatized AIKα rays (accelerating voltage 15 kV, 150 W) as the X ray source, a circular region having a diameter of about 11 nm was measured for the C1s peak and Si2p peak with a degree of vacuum of 1 to 9×10⁻⁸ torr, a take-off angle of 90°, and a pass energy of 40 eV thereby determining the abundance molar ratio of C/Si.

The arithmetic average of the carbon/silicon mass ratio in the region extending from the surface farthest from the support of the ink receiving layer to a depth of 5 μm may be measured by a common procedure; a section of the ink receiving layer vertical to the support is observed using an energy dispersive X-ray fluorescence spectrometer (SEM-EDX) attached to a scanning electron microscope (SEM). The SEM-EDX may be selected from common ones. Specifically, the measurement is carried out as follows using JSM-6700 manufactured by JEOL Ltd. and Genesis manufactured by EDAX Japan K.K.

Platinum is applied to the sample section in a thickness of 3 nm by sputter coating, the section is observed by SEM (accelerating voltage: 20 kV), and then the region extending from the outermost surface to a depth of 5 μm is scanned at a constant electron beam flow, and X rays are captured for 100 seconds. From the spectrum obtained, the arithmetic average of the C/Si mass ratio is calculated.

(Silica Fine Particles)

The ink receiving layer in the inkjet recording material of the invention contains at least one kind of silica fine particles, and as necessary, may contain other inorganic fine particles without impairing the effect of the invention. Specific examples of other inorganic fine particles include titanium dioxide, barium sulfate, calcium silicate, zeolite, kaolinite, halloysite, mica, talc, calcium carbonate, magnesium carbonate, calcium sulfate, boehmite, and pseudo-boehmite.

The silica fine particle has an extremely high specific surface area, and provides the layer with a higher ink absorption and retention capacity. In addition, the silica has a low refractive index, and thus if dispersed to a suitable fine particle diameter, provides the ink receiving layer with better transparency, and higher color density and favorable coloring is obtainable. The transparency of ink receiving layer is important from the viewpoint of obtaining a high color density, coloring property and favorable coloring glossiness not only for applications wherein the transparency is required such as OHP sheets and the like, but also for applications as recording sheets such as photographic glossy papers and the like.

The average primary particles diameter of the silica fine particles is preferably 20 nm or less, more preferably 15 nm or less, and particularly preferably 10 nm or less. When the average primary particle size of the particles is 20 nm or less, the ink-absorbing property can be effectively improved and at the same time, the glossiness of the surface of the ink receiving layer can be enhanced.

The specific surface area of the silica fine particle as determined by the BET method is preferably 200 m²/g or more, more preferably 250 m²/g or more, and still more preferably 380 m²/g or more. Inorganic fine particles having a specific surface area of 200 m²/g or more give an ink image-receiving layer higher in transparency and printing density.

The BET method used in the invention is a method of determining the surface area of powder by gas-phase adsorption, more specifically a method of determining the specific surface area, i.e., the total surface area per g of a sample, from the absorption isotherm. Nitrogen gas is commonly used as the adsorption gas, and most widely used is a method of determining the amount of adsorption by the change in pressure or volume of the adsorbed gas. One of the most famous equations describing the adsorption isotherm of multi-molecular system is the equation of Brunauer, Emmett, and Teller (BET equation). The surface area is calculated by multiplying the adsorption amount determined by

In particular with silica fine particles, since the surface has silanol groups, there is easy adhesion between the particles through the hydrogen bonding of the silanol groups, and there is an adhesion effect between the particles through the silanol groups and the water soluble resin. Hence, if the average primary size of the particles is 20 nm or below, then the porosity ratio of the ink receiving layer is high, and a structure with high transparency can be formed, and the ink absorption characteristics can be effectively raised.

Silica fine particles are commonly classified roughly into wet method particles and dry method (vapor phase process) particles according to the method of manufacture. By the wet method, silica fine particles are mainly produced by generating an activated silica by acid decomposition of a silicate, polymerizing to a proper degree the activated silica, and coagulating the resulting polymeric silica to give a hydrated silica. Alternatively by the vapor phase process, anhydrous silica particles are mainly produced by high-temperature vapor phase hydrolysis of a silicon halide (flame hydrolysis process), or by reductively heating and vaporizing quartz and coke in an electric furnace by applying an arc discharge and then oxidizing the vaporized silica with air (arc method). The “vapor-phase process silica” means an anhydrous silica fine particle produced by a vapor phase process.

The vapor-phase process silica is different in the density of silanol groups on the surface and the presence of voids therein and exhibits different properties from hydrated silica. The vapor-phase process silica is suitable for forming a three-dimensional structure having a higher void percentage. The reason is not clearly understood. In the case of hydrated silica fine particles have a higher density of 5 to 8 silanol groups/nm² on their surface. Thus the silica fine particles tend to coagulate (aggregate) densely. While the vapor phase process silica particles have a lower density of 2 to 3 silanol groups/nm² on their surface. Therefore, vapor-phase process silica seems to cause more scarce, softer coagulations (flocculates), consequently leading to a structure having a higher void percentage.

In the invention, fine particles of the vapor-phase process silica (anhydrous silica) obtained by above-described dry process are preferable, and silica fine particles having a density of 2 to 3 silanol groups/nm² on their surface are more preferable.

In the invention, the most preferable silica fine particles are vapor-phase process silica having a specific surface area of 200 m²/g or more as determined by the BET method.

(Water-Soluble Resin)

The ink receiving layer in the inkjet recording material of the invention contains at least one kind of water-soluble resin. Examples of the water-soluble resins include polyvinyl alcohols (PVAs) having a hydroxyl group as a hydrophilic structural unit, cationic modified polyvinyl alcohols, anionic modified polyvinyl alcohols, silanol-modified polyvinyl alcohols, polyvinylacetal, cellulosic resins (methylcellulose (MC), ethylcellulose (EC), hydroxyethylcellulose (HEC), carboxymethylcellulose (CMC), hydroxypropylcellulose (HPC), etc.), chitins, chitosans, and starch; hydrophilic ether bond-containing resins such as polyethylene oxide (PEO), polypropylene oxide (PPO), polyethylene glycol (PEG), and polyvinylether (PVE); hydrophilic amide group- or amide bond-containing resins such as polyacrylamide (PAAM) and polyvinyl pyrrolidone (PVP); and the like. Other examples include compounds having a carboxyl group as a dissociative group such as polyacrylate salts, maleic acid resins, alginate salts, gelatins, and the like.

Polyvinyl alcohol resins are preferable as the water-soluble resins of the exemplary embodiment of the invention from the view point of glossiness and ink-absorbency of the inkjet recording materials.

The above polyvinyl alcohol resins contain a hydroxyl group as a structural unit. Hydrogen bonding between the hydroxyl groups and the surface silanol groups on silica fine particles allows the silica fine particles to form a three-dimensional network structure having secondary particles as the network chain units. This three-dimensional network structure thus constructed seems to be the cause of easier development of an ink receiving layer having a porous structure having a higher void percentage.

In ink jet recording materials, the ink receiving layer having a porous structure obtained in this manner absorbs inks rapidly due to the capillary phenomenon, and provides printed dots superior in circularity without ink bleeding.

In the invention, the degree of saponification of the polyvinyl alcohol is not particularly limited, and may be, for example, from 80 to 99.8 mol %. In particular, from the viewpoints of ink absorbency and stable formation of the ink receiving layer, the degree of saponification is preferably from 92 to 98 mol %, and more preferably from 93 to 97 mol %.

Further, in the invention, the degree of polymerization of the polyvinyl alcohol is not particularly limited, and may be, for example, from 300 to 4500. In particular, from the viewpoints of prevention of cracks of the ink receiving layer and stable formation of the ink receiving layer, the degree of polymerization is preferably from 1500 to 3600, and more preferably from 2000 to 3500.

In the invention, the polyvinyl alcohol as a water-soluble resin may be combined with other water-soluble resin as necessary. When the polyvinyl alcohol is combined with other water-soluble resin, the proportion of the other water-soluble resin is preferably from 1 to 30% by mass, more preferably from 3 to 20% by mass, and particularly preferably from 6 to 12% by mass with respect to the total of the polyvinyl alcohol and other water-soluble resin.

In order to prevent reduction of layer strength or layer cracking at the time when the layer is dried, due to too small a content of the water-soluble resin, and prevent reduction of ink absorbing ability caused by blocking of voids by resin due to too high a content of resin, the content of the water-soluble resins of the present invention is preferably 9 to 40%, more, preferably 12 to 33% by mass with respect to the total solid mass in ink receiving layer.

(Content Ratio Between Silica Fine Particles and Water-Soluble Resin)

In the invention, the content ratio of the silica fine particles (x) and water-soluble resin (y) [PB ratio (x/y), the mass of the silica fine particles with respect to 1 part by mass of the water-soluble resin] in the whole ink receiving layer markedly influences the layer structure of the ink receiving layer.

That is, as a PB ratio grows larger, a porosity, a micropore volume and a specific surface area (per unit mass) grow larger.

Specifically, the PB ratio (x/y) is preferably 1.5/1 to 10/1 from a viewpoint that reduction in the film strength and cracking at drying due to too large PB ratio are prevented, and due to too small PB ratio, a void is easily filled with a resin, and a porosity is reduced, and reduction in the ink absorbing property is prevented.

When conveyed in paper-conveying systems of ink jet printers, a stress may be applied to the ink jet recording materials. Accordingly, the ink receiving layer should have sufficiently high layer strength. Also from the viewpoints of preventing cracking, peeling, or the like of the ink receiving layer when the ink jet recording materials are cut into sheets, the ink receiving layer should have sufficiently high layer strength. Considering the above, the PB ratio is preferably 5/1 or less. On the other hand, from the viewpoint of ensuring the superior ink absorptive property in ink jet printers, the ratio is more preferably 2/1 or more.

For example, when a coating solution, which has been made by thoroughly dispersing anhydrous silica fine particles having a primary particle size of 20 nm or less and the polyvinyl alcohol according to the invention in an aqueous solution at a PB ratio (x/y) of 2/1 to 5/1, is applied to a support, and the coating layer is dried, a three-dimensional net structure composed chain units of secondary particles of silica fine particles is formed, and thus a translucent porous layer having an average pore diameter of 30 nm or less, porosity of 50% to 80%, a micropore ratio volume of 0.5 ml/g or more, and a specific surface area of 100 m²/g or more is readily formed.

(Crosslinking Agent)

The ink-receiving layer according to the invention contains a crosslinking agent preferably from the view point of strength of the ink-receiving layer. The ink-receiving layer according to the exemplary embodiment of the invention is preferably a porous layer of the water-soluble resins which are hardened in crosslinking reaction by the crosslinking agent.

The cross-linking agent may be selected from those suitable for the water-soluble resin contained in the ink receiving layer. For example, when polyvinyl alcohol is used as the water-soluble resin, boron compounds are preferable since they are able to promptly cause a cross-linking reaction. Examples of the boron compounds include borax, boric acid, borate salts [e.g., orthoborate salts, InBO₃, ScBO₃, YBO₃, LaBO₃, Mg₃(BO₃)₂, and Co₃(BO₃)₂], diborate salts [e.g., Mg₂B₂O₅, and Co₂B₂O₅], metaborate salts [e.g., LiBO₂, Ca(BO₂)₂, NaBO₂, and KBO₂], tetraborate salts [e.g., Na₂B₄O₇.10H₂O], pentaborate salts [e.g., KB₅O₈.4H₂O, Ca₂B₆O₁₁.7H₂O, and CsB₅O₅], and the like. Among them, borax, boric acid and borates are preferable since they are able to promptly cause a cross-linking reaction. Particularly, boric acid or a borate salt is preferable, and the combination of this and polyvinyl alcohol, which is a water-soluble resin, is most preferred.

In the invention, the above cross-linking agent is preferably included to an amount of 0.05 to 0.50 parts by weight relative to 1 part by weight of the polyvinyl alcohol of the present invention. More preferable is an inclusion amount of 0.08 to 0.30 parts by weight. If the amount of inclusion of the cross-linking agent is within the above ranges then the polyvinyl alcohol of the present invention can be effectively be cross-linked and development of cracks and the like can be prevented.

When gelatin is used as a water-soluble resin in the invention, other compounds than the boron compounds, as described below, can be used for the cross-linking agent of the water-soluble resin.

Examples of such cross-linking agents include: aldehyde compounds such as formaldehyde, glyoxal and glutaraldehyde; ketone compounds such as diacetyl and cyclopentanedione-active halogen compounds such as bis(2-chloroethylurea) -2-hydroxy-4,6-dichloro-1,3,5-triazine and 2,4-dichloro-6-S-triazine sodium salt; active vinyl compounds such as divinyl sulfonic acid, 1,3-vinylsulfonyl-2-propanol, N,N′-ethylenebis(vinylsulfonylacetamide) and 1,3,5-tiacryloyl-hexahydro-S-triazine; N-methylol compounds such as dimethylolurea and methylol dimethylhydantoin; melamine resin such as methylolmelamine and alkylated methylolmelamine; epoxy resins;

isocyanate compounds such as 1,6-hexamethylenediisocyanate; aziridine compounds such as those described in U.S. Pat. Nos. 3,017,280 and 2,983,611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecular compounds or polymers containing at least two oxazoline groups. These crosslinking agents may be used alone, or in combinations of two or more thereof.

(Water-Soluble Aluminum Compound)

The ink-receiving layer according to the invention contains a water-soluble aluminum compound. Presence of a water-soluble aluminum compound is effective in improving the water resistance and ink-bleeding resistance during long term storage of the formed image.

Examples of the water-soluble aluminum compounds include inorganic salts such as aluminum chloride or the hydrates thereof, aluminum sulfate or the hydrates thereof, ammonium alum, and the like. Other examples include inorganic aluminum-containing cationic polymers such as basic polyaluminum hydroxide compounds. Among them, basic polyaluminum hydroxide compounds are preferable.

The above basic polyaluminum hydroxide compounds are water soluble polyaluminum hydroxide compounds stably including multi-nucleated condensate ions of basic polymers, such as [Al₆(OH)₁₅]³⁺, [Al₈(OH)₂₀]⁴⁺, [Al₁₃(OH)₃₄]⁵⁺, [Al₂₁(OH)₆₀]³⁺, and the major components thereof are represented by the following formulae.

[Al₂(OH)ₙCl₆₋ₙ]ₘ 5<m<80, 1<n<5 Formula 1

[Al(OH)₃]ₙAlCl₃ 1<n<2 Formula 2

Alₙ(OH)ₘCl₍₃ₙ₋ₘ₎ 0<m<3n, 5<m<8 Formula 3

These compounds of various grades can be easily obtained and are placed on the market by Taki Chemical Co. Ltd. as polyaluminum chloride (PAC) as water treatment agents, by Asada Kagaku Co. Ltd. as polyhydrated aluminium (Paho), also by Rikengreen Co. Ltd., as pyurakem WT, Taimei Chemicals Co. Ltd., as alphaine 83, and other manufacturers for the same purpose. In the invention it is suitable to use the commercially available products directly, but since there are materials which have inappropriately low pH values, in these cases it is possible to use by suitably adjusting the pH.

The content of the water-soluble aluminum compound in the ink-receiving layer according to the invention is preferably 0.1 to 20 wt %, more preferably 1 to 8 wt %, and most preferably 2 to 4 wt %, with respect to the total solids in the ink-receiving layer. A water-soluble aluminum compound content in the range of 2 to 4 wt % is effective in improving glossiness, water resistance, gas resistance, and light stability.

(Zirconium Compound)

The ink-receiving layer according to the invention contains a zirconium compound preferably. Use of the zirconium compound allows improvement in water resistance.

The zirconium compound for use in the invention is not particularly limited, and various compounds may be use, and typical examples thereof include zirconyl acetate, zirconium chloride, zirconium oxychloride, zirconium hydroxychloride, zirconium nitrate, basic zirconium carbonate, zirconium hydroxide, zirconium ammonium carbonate, zirconium potassium carbonate, zirconium sulfate, zirconium fluoride compound, and the like. Zirconyl acetate is particularly preferable.

The content of the zirconium compound in the ink-receiving layer according to the invention is preferably 0.05 to 5.0 wt %, more preferably 0.1 to 3.0 wt %, and particularly preferably 0.5 to 2.0 wt %, with respect to the total solids in the ink-receiving layer. A zirconium compound content in the range of 0.5 to 2.0 wt % allows improvement in water resistance without deterioration in ink-absorbing efficiency.

In the invention, a water-soluble polyvalent metal compound other than the water-soluble aluminum compound and the zirconium compound described above may be used in combination. Examples of the other water-soluble polyvalent metal compounds include water-soluble salts of a metal selected from calcium, barium, manganese, copper, cobalt, nickel, iron, zinc, chromium, magnesium, tungsten, and molybdenum.

Typical examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, and the like.

(Other Components)

In addition, the ink receiving layer of the present invention is constructed to contain the following components if necessary.

To restrain the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivatives and benzotriazolyl phenol derivatives. Specific examples include α-cyano-phenyl cinnamic acid butyl ester, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenol derivatives in which at least one or more of the second place and/or the sixth place is substituted by a branching alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers as described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

An optical whitening agent can be also used as an ultraviolet absorber, and specific examples include a coumalin based optical whitening agent. Specific examples are described in JP-B Nos. 45-4699 and 54-5324 or the like.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536,

63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethy-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methy-4-methoxy-diphenylamine, 1-methyl-2-phenyl indole.

These anti-fading agents can be used alone or in combinations of two or more. The anti-fading agents can be dissolved in water, dispersed, emulsified, or they can be included within microcapsules. The amount of the anti-fading agents added is preferably 0.01 to 10% by mass, relative to the total ink receiving layer coating liquid.

In the invention, in order to prevent curl, it is preferable to include organic solvents with a high boiling point in the ink receiving layer.

For the above high boiling point organic solvents water soluble ones are preferable. As water soluble organic solvents with high boiling points the following alcohols are examples: ethylene glycol, propylene glycol, diethylene glycol, triethylene glycol, glycerin, diethylene glycol monobutylether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of less than 400). Diethylene glycol monobutylether (DEGMBE) is preferable.

The amount of the above high boiling point organic solvents used in the coating liquid for the ink receiving layer is preferably 0.05 to 1% by mass, and particularly favorable is 0.1 to 0.6% by mass.

Also, for the purpose of increasing the dispersability of the inorganic fine particles, inorganic salts, and acids or alkalis, for the pH adjuster, can be included Further, in order to suppress the generation of friction charging and exfoliation charging on the surface, conductive metallic oxide fine particles, and matting agents, for reducing the surface friction, can be included.

(Support)

Both a transparent support of a transparent material such as plastic and an opaque support of an opaque material such as paper may be used as the support. Use of a transparent support or an opaque high-glossiness support is preferable, for making the most of the transparency of ink-receiving layer. It is also possible to use a read-only optical disk such as CD-ROM or DVD-ROM, a write once optical disk such as CD-R or DVD-R, or rewritable optical disk as the support and form an ink-receiving layer on the label face thereof.

Material which is transparent and can endure radiant heat when used on OHPs and a backlight display is preferable as a material which can be used for the above transparent support. Examples of the material include polyesters such as polyethylene terephthalate (PET); polysulfone, polyphenylene oxide, polyimide, polycarbonate and polyamide. The polyesters are preferable among them, and especially, polyethylene terephthalate is preferable.

The thickness of the transparent support is not particularly limited. However, a thickness of 50 to 200 μm is preferable in view of ease of use.

An opaque support having high glossiness whose surface on which the ink receiving layer is formed has a glossiness degree of 40% or more is preferable. The glossiness degree is a value determined according to the method described in JIS P-8142 (paper and a paperboard 75 degree method for examining specular glossiness degree). Specific examples of such supports include the following supports.

Examples include paper supports having high glossiness such as art paper, coat paper, cast coat paper and baryta paper used for a support for a silver salt photography or the like; polyesters such as polyethylene terephthalate (PET), cellulose esters such as nitrocellulose, cellulose acetate and cellulose acetate butyrate, opaque high glossiness films which are constituted by incorporating white pigment or the like in plastic films such as polysulfone, polyphenylene oxide, polyimide, polycarbonate and polyamide (a surface calendar treatment may be performed); or, supports in which a coating layer made of polyolefin which either does or does not contain a white pigment is formed on the surface of the various paper supports, transparent supports or a high glossiness film containing white pigment or the like.

Also, white pigment-containing foam polyester film (for instance, a foam PET which contains the polyolefin fine particles, and contains voids formed by drawing out) is preferable. Further, a resin coated paper to be used for a printing paper for silver halide salt photographic use is suitable.

The thickness of the opaque support is not particularly limited. However, a thickness of 50 to 300 μm is preferable in view of ease of handling.

The surface of the support may be treated by corona discharge treatment, glow discharge treatment, flame treatment or ultraviolet radiation treatment or the like, so as to improve wetting and adhesion properties.

Next, base paper used for paper support, such as resin coated paper, will be described.

The base paper is mainly made of wood pulp, and is made by using a synthetic pulp, such as polypropylene, in addition to the wood pulp if necessary, or a synthetic fiber such as nylon or polyester. LBKP, LBSP, NBKP, NBSP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass.

A chemical pulp with few impurities (sulfate pulp and sulfite pulp) is preferably used as the pulp, and a pulp in which whiteness is improved by bleaching, is useful.

Sizing agents such as higher fatty acid and alkyl ketene dimer, white pigments such as calcium carbonate, talc and titanium oxide, paper reinforcing agents such as starch, polyacrylamide and polyvinyl alcohol, optical whitening agents, water retention agents such as polyethylene glycols, dispersing agents, and softening agents such as a quaternary ammonium can be appropriately added to the base paper.

The freeness of pulp used for papermaking is preferably 200 to 500 ml as stipulated in CSF. The sum of 24 mesh remainder portions and 42 mesh remainder portions is preferably 30 to 70% by mass as stipulated in JIS P-8207. 4 mesh remainder portion is preferably 20% by mass.

The basis weight of the base paper is preferably 30 to 250 g/m², and particularly preferably 50 to 200 g/m². The thickness of the base paper is preferably 40 to 250 μm. High smoothness can be imparted to the base paper by calendar treatment at the making paper step or after paper making. The density of the base paper is generally 0.7 to 1.2 g/m² (JIS P-8118). In addition, the strength of the base paper is preferably 20 to 200 g under the conditions of JIS P-8143.

A surface size agent may be coated on the surface of the base paper, and a size agent which is the same as size which can be added to the base paper can be used as the surface size agent. It is preferable that the pH of the base paper is 5 to 9 when measured by a hot water extraction method provided by JIS P-8113.

In general, the both front and back surfaces of the base paper can be coated with polyethylene. Main examples of polyethylenes include low density polyethylene (LDPE) and/or high density polyethylene (HDPE) but others such as LLDPE and polypropylene can be also used in part.

Especially, in the polyethylene layer on the side on which the ink receiving layer is formed, it is preferable that rutile type or anatase type titanium oxide, an optical whitening agent or ultramarine blue pigment are added to polyethylene, and thereby the degree of opaqueness, whiteness and hue are improved, as is widely performed for printing papers for photographs. Herein, the content of titanium oxide is preferably about 3 to 20% by mass, and more preferably 4 to 13% by mass to polyethylene. The thickness of the polyethylene layer is not limited to a particular thickness, and more preferably 10 to 50 μm. Further, an undercoat layer can be formed to give adhesion of the ink receiving layer on the polyethylene layer. Water soluble polyester, gelatin, and PVA are preferably used as the undercoat layer. The thickness of the undercoat layer is preferably 0.01 to 5 μm.

A polyethylene coated paper sheet may be used as glossy paper, or when polyethylene is coated on the surface of the base paper sheet by melt-extrusion a matte surface or silk finish surface may be formed by applying an embossing treatment, as obtainable in usual photographic printing paper sheets.

On the support body a back coat layer can be provided, and white pigments, water soluble binders and other components can be used as additive components of the back coat layer.

Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene based plastic pigments, acrylic based plastic pigments, polyethylene, microcapsules, urea resin and melamine resin

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include defoaming agents, foaming suppressing agents, dyes, optical whitening agents, preservatives and water-proofing agents.

The inkjet recording materials of the invention may be made by applying an ink receiving layer coating solution containing at least silica fine particles and a water-soluble resin onto a support, and then drying the coating.

In the invention, the ink receiving layer coating solution may be prepared, for example, by counter-colliding silica fine particles against a zirconium compound using a high-pressure dispersing machine, or dispersing them by passing through an orifice to make a dispersion of the silica fine particles, and then adding a water-soluble resin to the dispersion.

The dispersion obtained by counter-colliding silica fine particles against a zirconium compound using a high-pressure dispersing machine, or dispersing them by passing through an orifice is excellent in fineness of the inorganic fine particles.

The mixture, “silica fine particles and zirconium compound”, is fed into a high-pressure dispersing machine, as it is in the dispersed (roughly dispersed) state. Preliminary mixing (rough dispersion) may be performed by common propeller agitating, turbine agitating, homomixer agitating, or the like.

The high-pressure dispersing machine for use in preparing the dispersion of the silica fine particles is generally, favorably a commercially available apparatus called high-pressure homogenizer.

Typical examples of the high-pressure homogenizers include Nanomizer (trade name, manufactured by Nanomizer), Microfluidizer (trade name, manufactured by Microfluidex Inc.), Ultimizer (manufactured by Sugino Machine Ltd.), and the like.

The orifice is a mechanism of restricting flow of liquid fed through a straight pipe with a thin plate having fine circular holes (orifice plate) inserted therein.

The high-pressure homogenizer is an apparatus basically consisting of a high pressure-generating unit for pressurizing, for example, raw material slurry and a counter-collision or orifice unit. Generally, a high-pressure pump called plunger pump is used favorably in the high pressure-generating unit. Any one of various kinds of high-pressure pumps, single pump, double pumps, triple pumps, and others, may be used in the invention without restriction.

The pressure when particles are counter-collided at high pressure is preferably 50 MPa or more, more preferably 100 MPa or more, and still more preferably 130 MPa or more.

The pressure difference between the inlet and the outlet of orifice during processing is also preferably 50 MPa or more, more preferably 100 MPa or more, and still more preferably 130 MPa or more, similarly to the processing pressure above.

The collision speed during counter collision of preliminary dispersion is preferably 50 m/sec or more, more preferably 100 m/sec or more, and still more preferably 150 m/sec or more, as relative velocity.

The linear velocity of a solvent passing through the orifice may vary according to the pore size of the orifice used, but is preferably 50 m/sec or more, more preferably 100 m/sec or more, and still more preferably 150 m/sec or more, similarly to the collision speed during counter collision.

By any method, the dispersion efficiency depends on the processing pressure, and a higher processing pressure results in higher dispersion efficiency. However, a processing pressure of more than 350 MPa often causes problems in the pressure resistance of the piping of high-pressure pump and the durability of apparatus.

In any one of the methods described above, the frequency of processing is not particularly limited, and normally selected in the range of once to dozens of times. The dispersion is prepared in this manner.

Various additives may be added in preparation of the dispersion.

Examples of the additives include various nonionic or cationic surfactants (anionic surfactants are undesirable because of aggregation), antifoams, nonionic hydrophilic polymers (polyvinyl alcohol, polyvinyl pyrrolidone, polyethyleneoxide, polyacrylamide, various sugars, gelatin, pullulan, etc.), nonionic or cationic latex dispersions, water-miscible organic solvents (ethyl acetate, methanol, ethanol, isopropanol, n-propanol, acetone, etc.), inorganic salts, pH adjusters, and the like, and these additives are used as needed.

In particular, water-miscible organic solvents, which prevent microaggregation of silica fine particles during preliminary dispersion, are desirable. The water-miscible organic solvent is used in an amount of 0.1 to 20 wt %, particularly preferably 0.5 to 10 wt %, in the dispersion.

The pH during preparation of a silica fine particle dispersion may vary significantly, for example, according to the kinds of the silica fine particles used and the various additives added, but are generally 1 to 8, particularly preferably 2 to 7. Two or more additives may be used in combination in the dispersion.

To the dispersion of the silica fine particles obtained as described above, a water-soluble resin and others are added to obtain the ink receiving layer coating solution. Mixing of the dispersion of the silica fine particles and water-soluble resin may be carried out using, for example, an ordinary propeller agitating, a turbine agitating, or a homomixer agitating.

In the method of producing an inkjet recording materials according to the invention, examples of the in-line mixers favorably used in in-line mixing of the water-soluble aluminum compound in the ink-receiving layer-forming solution include, but are not limited to, those described in JP-A No. 2002-85948 and others.

In the inkjet recording material of the invention, for example, a coating layer is formed by applying a coating solution obtained by in-line mixing of the ink receiving layer coating solution and a water-soluble aluminum compound onto a support, and a basic solution having a pH of 7.1 or more is applied to the coating layer (1) concurrently with the application of the coating solution, or (2) before the coating layer exhibits a decreasing rate of drying during drying of the coating layer, and then the coating layer is cured by cross-linking thereby forming an ink receiving layer.

The formation of the cross-linked ink receiving layer as described above is preferable from the viewpoint of ink absorbency and prevention of film cracks.

In the preparation of the coating solution for forming an inkjet-receiving layer according to the invention, water, an organic solvent, or the mixed solvent thereof may be used as the solvent. Examples of the organic solvents for use in coating include alcohols such as methanol, ethanol, n-propanol, i-propanol, and methoxypropanol, ketones such as acetone and methylethylketone, tetrahydrofuran, acetonitrile, ethyl acetate, toluene, and the like.

The coating solution of the ink receiving layer can be coated by a known method, such as using an extrusion die coater, an air doctor coater, a blade coater, a rod coater, a knife coater, a squeeze coater, a reverse roll coater, or a bar coater.

The basic solution having a pH of 7.1 or more is applied on the coated layer formed by application of the ink-receiving layer-forming solution, simultaneously with application of the ink-receiving layer-forming solution or before the coated layer exhibits a falling drying rate during drying of the coated layer. Thus, the hardened layer is formed favorably by applying the basic solution having a pH of 7.1 or more on the coated layer during it shows a constant drying rate after application of the ink-receiving layer-forming solution.

The basic solution having a pH of 7.1 or more may contain a crosslinking agent and others as needed. The basic solution having a pH of 7.1 or more accelerates crosslinking as an alkaline solution, and thus, the pH thereof is preferably 7.5 or more, particularly preferably 7.9 or more. A pH closer to the acidic side may result in insufficient crosslinking of the polyvinyl alcohol contained in the ink-receiving layer-forming solution by the crosslinking agent, causing problems such as bronzing, cracking of the ink-receiving layer, and others.

The basic solution having a pH of 7.1 or more is prepared, for example, by adding a metal compound (e.g., 1 to 5%) and a basic compound (e.g., 1 to 5%), and also p-toluenesulfonic acid (e.g., 0.5 to 3%) as needed, to ion-exchange water and agitating the mixture thoroughly. “%” above of each component means solid weight %.

The phrase “before the coated layer exhibits a falling drying rate” normally means a period of few minutes after application of the coating solution for the ink-receiving layer, during which the coated layer shows a phenomenon of “constant drying rate” wherein the content of the solvent (dispersion medium) therein decreases linearly over time. The period of this “constant drying rate” is described, for example, in Chemical Engineering Handbook (pp. 707 to 712, published by Maruzen Co., Ltd., Oct. 25, 1980).

The ink-receiving layer-forming solution is dried after application generally at 40 to 180° C. for 0.5 to 10 minutes (preferably for 0.5 to 5 minutes), until the coated layer shows a falling drying speed as described above. The drying period, of course, varies according to the amount coated, but is favorably in the range above.

In order to form an ink receiving layer wherein the arithmetic average of the carbon/silicon mass ratio in the outermost surface is from 2.5 to 7.0, and the arithmetic average of the carbon/silicon mass ratio in the region extending from the outermost surface to a depth of 5 μm is from 1.5 to 4.0, for example, a very thin film having a high abundance ratio of a water-soluble resin is formed on the surface of the coating layer under severe drying conditions, and then the coating layer is dried to the inside under eased drying conditions, whereby an ink receiving layer having the above-described structure is formed.

The severe drying conditions and eased drying conditions referred herein may be controlled through, for example, the drying temperature, drying air quantity, and dew point of drying air according to, for example, the composition and coating weight of the ink receiving layer coating solution.

In the invention, from the viewpoints of glossiness and ink absorbency, it is preferable that the coating layer be dried at 70 to 120° C. until the solid content concentration of the coating layer becomes 14 to 20%, followed by drying at 40 to 60° C. until the solid content concentration of the coating layer becomes 21 to 27%, and it is more preferable that the coating layer be dried at 80 to 110° C. until the solid content concentration of the coating layer becomes 15 to 19%, followed by drying at 45 to 55° C. until the solid content concentration of the coating layer becomes 22 to 26%.

### EXAMPLES

Hereinafter, the present invention will be described in more detail with reference to Examples, but it should be understood that the invention is not restricted by the following Examples. “Part” and “%” in the following Examples refer to parts by mass.

### Example 1

(Making of Support)

50 parts of acacia LBKP and 50 parts of aspen LBKP were respectively beaten with a disc refiner to a Canadian freeness of 300 ml to make a pulp slurry.

Subsequently, to the pulp slurry, with respect to the pulp, 1.3% of cationic starch (trade name: CATO 304L, manufactured by Japan NSC), 0.15% of anionic polyacrylamide (trade name: POLYACRON ST-13, manufactured by Seiko Chemical Co.), 0.29% of an alkylketene dimmer (trade name: SIZEPINE K, manufactured by Arakawa Chemical Industries, Ltd.), 0.29% of epoxidized behenic acid amide, and 0.32% of polyamide polyamine epichlorohydrin (trade name: ARAFIX 100, manufactured by Arakawa Chemical Industries, Ltd.) were added, and then 0.12% of an anti-foaming agent was added.

The pulp slurry prepared as described above was made into a sheet with a fourdrinier machine, and the sheet was dried by pressing the felt surface of the web against the drum dryer cylinder via a dryer canvas with the tensile strength of the dryer canvas set at 1.6 kg/cm. Subsequently polyvinyl alcohol (trade name: KL-118, manufactured by Kuraray Co., Ltd.) was applied by size press to both the surfaces of the base paper in an amount of 1 g/m², dried, and the sheet was calendared. The base paper was produced at a basis weight of 157 g/m² and a thickness of 157 μm.

The wire surface (back surface) of the base paper was subjected to corona discharge treatment, and coated with a blend of high-density polyethylene/low-density polyethylene (80%/20%) to give a density of 20 g/m² at a temperature of 320° C. using a melt-processing extruder to form a thermoplastic resin layer having a matte surface (hereinafter the thermoplastic resin layer surface is referred to as “back surface”). The thermoplastic resin layer on the back side was further subjected to corona discharge treatment, and then coated with a dispersion as an anti-static agent, which had been prepared by dispersing aluminum oxide (trade name: ALUMINA SOL 100, manufactured by Nissan Chemical Industries, Ltd.) and silicon dioxide (trade name: SNOWTEX O, manufactured by Nissan Chemical Industries, Ltd.) in water at a mass ratio of 1:2, to give a dry mass density of 0.2 g/m². Subsequently, the surface was subjected to corona treatment, and coated with polyethylene containing 10% by mass of titanium oxide and having a density of 0.93 g/m² to give a density of 24 g/m² using a melt-processing extruder at 320° C.

—Preparation of Ink Receiving Layer Coating Solution A—

According to the following composition of “silica dispersion A”, silica fine particles, ion exchanged water, a dimethyldiallylammonium chloride polymer (trade name: SHAROLL DC902P, manufactured by Dai-Ichi Kogyo Seiyaku Co., Ltd.), and zirconyl acetate were mixed, and dispersed using a liquid-liquid impact disperser (ALTIMIZER, manufactured by Sugino Machine Limited). The dispersion was heated to 45° C., and kept at the temperature for 20 hours thereby making a silica dispersion A.

To the dispersion A, 31.2 parts of a polyvinyl alcohol (water-soluble resin) solution A having the following composition was added at 30° C., and thus an ink receiving layer coating solution A was prepared.

The mass ratio of the silica fine particles to the water-soluble resin (P/B ratio=silica fine particles/water-soluble resin) in the ink receiving layer coating solution A was 4.0/1, and the pH of the solution was 3.4.

“Silica dispersion A”

| | | |
|---|---|---|
| (1) | silica fine particles | 8.9 parts |
| | (trade name: AEROSIL 300SF75, manufactured by | |
| | Nippon Aerosil Co., Ltd.) | |
| (2) | ion exchanged water | 1.0 part |
| (3) | “SHAROLL DC-902P” (51.5% solution) | 0.78 parts |
| | (dispersant, manufactured by Dai-Ichi Kogyo | |
| | Seiyaku Co., Ltd.) | |
| (4) | zirconyl acetate (50% solution) | 0.48 parts |
| | (trade name: ZIRCOSOL ZA-30, manufactured by | |
| | Daiichi Kigenso Kagaku Kogyo Co., Ltd.) | |

“Polyvinyl alcohol (water-soluble resin) solution A”

| | | |
|---|---|---|
| (1) | polyvinyl alcohol | 2.2 parts |
| | (trade name: JM-33, manufactured by Japan Vam & | |
| | Poval Co., Ltd., degree of saponification: 94.3 mol %, | |
| | degree of polymerization: 3300) | |
| (2) | ion exchanged water | 28.2 parts |
| (3) | diethylene glycol monobutyl ether | 0.7 parts |
| | (trade name: BUTYCENOL 20P, manufactured by | |
| | Kyowa Hakko Chemical Co., Ltd.) | |
| (4) | polyoxyethylene lauryl ether | 0.1 parts |
| | (trade name: EMULGEN 109P, manufactured by | |
| | Kao Corporation) | |

<Preparation of Ink Receiving Layer Coating Solution B>

According to the following composition of “silica dispersion B”, silica fine particles, ion exchanged water, a dimethyldiallylammonium chloride polymer (trade name: SHAROLL DC902P, manufactured by Dai-Ichi Kogyo Seiyaku Co., Ltd.), and zirconyl acetate were mixed, and dispersed using a liquid-liquid impact disperser (ALTIMIZER, manufactured by Sugino Machine Limited). The dispersion was heated to 45° C., and kept at the temperature for 20 hours thereby making a silica dispersion B.

To the dispersion B, 31.2 parts of a polyvinyl alcohol (water-soluble resin) solution B having the following composition and 3.1 parts of cation-modified polyurethane (trade name: SUPERFLEX 650 (25% solution) manufactured by Dai-Ichi Kogyo Seiyaku Co., Ltd.) were added at 30° C., and thus an ink receiving layer coating solution B was prepared.

The mass ratio of the silica fine particles to the water-soluble resin (P/B ratio=silica fine particles/water-soluble resin) in the ink receiving layer coating solution B was 4.0/1, and the pH of the solution was 3.8.

“Silica dispersion B”

| | | | |
|---|---|---|---|
| (1) | silica fine particles | 8.9 | parts |
| | (trade name: AEROSIL 300SF75, manufactured by | | |
| (2) | Nippon Aerosil Co., Ltd.) ion exchanged water | 1.0 | part |
| (3) | “SHAROLL DC-902P” (51.5% solution) | 0.78 | parts |
| | (dispersant, manufactured by Dai-Ichi Kogyo | | |
| (4) | Seiyaku Co., Ltd.) zirconyl acetate (50% solution) | 0.24 | parts |
| | (trade name: ZIRCOSOL ZA-30, manufactured by | | |
| | Daiichi Kigenso Kagaku Kogyo Co., Ltd.) | | |
| (5) | 30% methionine sulfoxide | 1.76 | parts |
| (6) | boric acid (cross-linking agent) | 0.4 | parts |

“Polyvinyl alcohol (water-soluble resin) solution B”

| | | |
|---|---|---|
| (1) | polyvinyl alcohol | 2.2 parts |
| | (trade name: JM-33, manufactured by Japan Vam & | |
| | Poval Co., Ltd., degree of saponification: 94.3 mol %, | |
| | degree of polymerization: 3300) | |
| (2) | ion exchanged water | 28.2 parts |
| (3) | diethylene glycol monobutyl ether | 0.7 parts |
| | (trade name: BUTYCENOL 20P, manufactured by | |
| | Kyowa Hakko Chemical Co., Ltd.) | |
| (4) | polyoxyethylene lauryl ether | 0.1 parts |
| | (trade name: EMULGEN 109P, manufactured by | |
| | Kao Corporation) | |

<Making of Inkjet Recording Material>

The front side of the support was subjected to corona discharge treatment, and then a lower layer coating solution made by in-line mixing the ink receiving layer coating solution B with a in-line solution having the following composition at rates of 97 ml/m² and 6.4 ml/m², respectively, and an upper layer coating solution made by in-line mixing the ink receiving layer coating solution A with a in-line solution having the following composition at rates of 88 ml/m² and 19.2 ml/m², respectively were applied using an extrusion die coater, whereby a coating layer was formed.

Subsequently, the coating layer was dried using a hot air drier at 90° C. (dew point: 5° C.) at a wind speed of 3 to 8 m/second until the solid content concentration of the coating layer became 17%, and then at 55° C. (dew point: 5° C.) at a wind speed of 3 to 8 m/second) until the solid content concentration of the coating layer became 24%. During that time, the coating layer exhibited a constant rate of drying.

Immediately after the drying, the coating layer was immersed in a basic solution having the following composition for 3 seconds thereby attaching the solution to the coating layer at a density of 13 g/m², and dried at 72° C. for 10 minutes. In this way, an inkjet recording material of Example 1 provided with an ink receiving layer having a thickness of 35 μm was made.

“In-line solution”

| | | |
|---|---|---|
| (1) | polyaluminum chloride aqueous solution | 2.0 parts |
| | (trade name: ALUFINE 83, manufactured by Taimei | |
| | Chemicals Co., Ltd., basicity: 83%) | |
| (2) | ion exchanged water | 7.8 parts |
| (3) | SC-505 (manufactured by HYMO Co., Ltd.) | 0.2 parts |

“Basic solution”

| | | |
|---|---|---|
| (1) | boric acid | 1.3 parts |
| (2) | ammonium carbonate (first class) | 5.0 parts |
| | (manufactured by Kanto Chemical Co., Inc.) | |
| (3) | zirconium carbonate ammonium | 2.5 parts |
| | (28% aqueous solution) (trade name: | |
| | ZIRCOSOL AC-7, manufactured by Daiichi | |
| | Kigenso Kagaku Kogyo Co., Ltd.) | |
| (4) | ion exchanged water | 85.2 parts |
| (5) | polyoxyethylene lauryl ether | 6.0 parts |
| | (trade name: EMULGEN 109P, manufactured by Kao | |
| | Corporation, 10% aqueous solution, | |
| | HLB value: 13.6) | |

### Example 2

An inkjet recording material was made in a manner substantially similar to Example 1, except that the coating layer was dried at 105° C. (dew point: 23° C.) in place of 90° C. until the solid content concentration of the coating layer became 17%, and dried at 50° C. (dew point: 23° C.) in place of 55° C. until the solid content concentration of the coating layer became 24%.

### Example 3

<Preparation of Ink Receiving Layer Coating Solution C>

According to the following composition of “silica dispersion C”, silica fine particles, ion exchanged water, a dimethyldiallylammonium chloride polymer (trade name: SHAROLL DC902P, manufactured by Dai-Ichi Kogyo Seiyaku Co., Ltd.), and zirconyl acetate were mixed, and dispersed using a liquid-liquid impact disperser (ALTIMIZER, manufactured by Sugino Machine Limited). The dispersion was heated to 45° C., and kept at the temperature for 20 hours thereby making a silica dispersion C.

To the dispersion C, 31.2 parts of a polyvinyl alcohol (water-soluble resin) solution C having the following composition, 0.4 parts of boric acid, 2.2 parts of cation-modified polyurethane (trade name: SUPERFLEX 650 (25% solution) manufactured by Dai-Ichi Kogyo Seiyaku Co., Ltd.), and 0.23 parts of SC-505 (manufactured by HYMO Co., Ltd.) were added at 30° C., and thus an ink receiving layer coating solution C was prepared.

“Silica dispersion C”

| | | | |
|---|---|---|---|
| (1) | silica fine particles | 8.9 | parts |
| | (trade name: AEROSIL 300SF75, manufactured by | | |
| (2) | Nippon Aerosil Co., Ltd.) ion exchanged water | 50 | parts |
| (3) | “SHAROLL DC-902P” (51.5% solution) | 0.78 | parts |
| | (dispersant, manufactured by Dai-Ichi Kogyo | | |
| | Seiyaku Co., Ltd.,) | | |
| (4) | zirconyl acetate (50% solution) | 0.48 | parts |
| | (trade name: ZIRCOSOL ZA-30, manufactured by | | |
| | Daiichi Kigenso Kagaku Kogyo Co., Ltd.) | | |

“Polyvinyl alcohol (water-soluble resin) solution C”

| | | |
|---|---|---|
| (1) | polyvinyl alcohol | 2.2 parts |
| | (trade name: PVA235, manufactured by Kuraray Co., | |
| | Ltd., degree of saponification: 88 mol %, degree of | |
| | polymerization: 3500) | |
| (2) | ion exchanged water | 28 parts |
| (3) | diethylene glycol monobutyl ether | 0.7 parts |
| | (trade name: BUTYCENOL 20P, manufactured by | |
| | Kyowa Hakko Chemical Co., Ltd.) | |
| (4) | polyoxyethylene lauryl ether | 0.1 parts |
| | (trade name: EMULGEN 109P, manufactured by | |
| | Kao Corporation) | |

<Making of Inkjet Recording Material>

The front side of the support made in a manner substantially similar to Example 1 was subjected to corona discharge treatment, and then a coating solution made by in-line mixing the ink receiving layer coating solution C with an in-line solution having the following composition at rates of 206 ml/m² and 12 ml/m², respectively, whereby a coating layer was formed.

Subsequently, the coating layer was dried using a hot air drier at 90° C. (dew point: 5° C.) at a wind speed of 3 to 8 m/second until the solid content concentration of the coating layer became 17%, and then at 55° C. (dew point: 5° C.) at a wind speed of 3 to 8 m/second) until the solid content concentration of the coating layer became 24%. During that time, the coating layer exhibited a constant rate of drying.

Immediately after the drying, the coating layer was immersed in a basic solution having the following composition for 3 seconds thereby attaching the solution to the coating layer at a density of 13 g/m², and dried at 72° C. for 10 minutes. In this way, an inkjet recording material of Example 3 provided with an ink receiving layer having a thickness of 35 μm was made.

### Comparative Example 1

The front side of the support made in a manner substantially similar to Example 1 was subjected to corona discharge treatment, a subbing layer having the following composition was formed to give a gelatin content of 50 mg/m², and then a coating layer of the ink receiving layer coating solution was formed on the subbing layer in a manner substantially similar to Example 1. After cooling at 5° C. for 30 seconds, the coating layer was dried at 45° C. (dew point: 5° C.), and thus an inkjet recording material was made without application of a basic solution.

“Subbing layer”

| | | |
|---|---|---|
| (1) lime-processed gelatin | 100 | parts |
| (2) sulfosuccinic acid-2-ethylhexyl ester salt | 2 | parts |
| (3) chromium alum | 10 | parts |

### Comparative Example 2

An inkjet recording material was made in a manner substantially similar to Example 1, except that the coating layer was dried at 100° C. (dew point: 23° C.) in place of 90° C. until the solid content concentration of the coating layer became 17%, and dried at 65° C. (dew point: 23° C.) in place of 55° C. until the solid content concentration of the coating layer became 24%.

### Comparative Example 3

<Preparation of ink receiving layer coating solution D>

An ink receiving layer coating solution D having the following
composition was prepared through dispersion in a homogenizer such
that the solid contentconcentration of the vapor-phase process silica
was 9%.

“Ink receiving layer coating solution D”

| | | | |
|---|---|---|---|
| (1) | vapor-phase process silica | 100 | parts |
| | (average primaryparticle size: 7 nm, specific surface | | |
| | area as determined by the BET method: 300 m²/g, | | |
| | degree of dispersion: 0.4) | | |
| (2) | dimethyldiallyl ammonium chloride polymer | 4 | parts |
| (3) | boric acid | 8 | parts |
| (4) | polyvinyl alcohol | 40 | parts |
| | (degree of saponification: 88 mol %, degree of | | |
| | polymerization: 3500) | | |
| (5) | surfactant | 0.3 | parts |

<Preparation of Ink Receiving Layer Coating Solution E>

An ink receiving layer coating solution E having the following composition was prepared through dispersion in a homogenizer such that the solid content concentration of the vapor-phase process silica was 9%.

“Ink receiving layer coating solution E”

| | | | |
|---|---|---|---|
| (1) | vapor-phase process silica | 100 | parts |
| | (average primary particle size: 7 nm, specific surface | | |
| | area as determined by the BET method: 300 m²/g, | | |
| | degree of dispersion: 0.4) | | |
| (2) | dimethyldiallyl ammonium chloride polymer | 4 | parts |
| (3) | boric acid | 4 | parts |
| (4) | polyvinyl alcohol | 20 | parts |
| | (degree of saponification: 88 mol %, degree of | | |
| | polymerization: 3500) | | |
| (5) | surfactant | 0.3 | parts |

<Making of Inkjet Recording Material>

The front side of the support made in a manner substantially similar to Example 1 was subjected to corona discharge treatment, and then a subbing layer having the following composition was formed to give a gelatin content of 50 mg/m². To the subbing layer, the ink receiving layer coating solution E as the lower layer coating solution and the ink receiving layer coating solution D as the upper layer coating solution were simultaneously applied using a slide bead coater such that the content ratio of the vapor-phase process silica in the lower layer to the upper layer was 90/10 (lower layer/upper layer), and the total coating weight of the vapor-phase process silica was 15 g/m². Thus a coating layer was formed.

After cooling at 5° C. for 30 seconds, the coating layer was dried at 45° C. (10% RH) until the solid content concentration became 90%, and then at 35° C. (10% RH) thereby making an inkjet recording material.

### Comparative Example 4

<Preparation of Silica Dispersion F>

46 kg of vapor-phase process silica (trade name: QS-20, manufactured by Tokuyama Corp.) having an average primary particle size of 12 nm was aspirated by a jet stream inductor mixer D-TDS (manufactured by Mitamura Riken Kogyo Inc.) and dispersed at room temperature in pure water whose pH had been adjusted to 3.0 with nitric acid, and pure water was added thereto to make the whole amount into 200 L, whereby a silica dispersion-1 was prepared.

To 13 L of an aqueous solution (adjusted to a pH of 2.5 with nitric acid) containing 1 kg of the cationic polymer (P-1) shown below, 4.2 L of ethanol, and 1.5 L of n-propanol, 44 L of the silica dispersion-I prepared as described above was added under stirring, to which 6.0 L of an aqueous solution containing 210 g of boric acid and 190 g of borax was added, and then 1 g of an anti-foaming agent (trade name: SN381, manufactured by San Nopco Limited) was added. The mixed solution was quickly stirred at 1500 rpm for 1 hours, and uniformly dispersed at 30 MPa using a high pressure homogenizer manufactured by Sanwa Industries Co., Ltd. Pure water was added to make the whole amount into 62 L, and the obtained dispersion was filtered through a filter (trade name: TCP-30, filtration accuracy: 30 μm, manufactured by Advantec Toyo Kaisha, Ltd.), whereby a silica dispersion F was prepared.

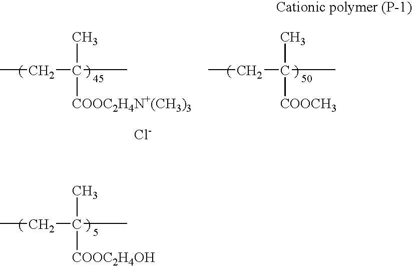

<Preparation of Ink Receiving Layer Coating Solution F>

To 610 ml of the silica dispersion F under stirring at 40° C., the following additives were subsequently added, pure water was added to the mixture to make 1000 ml, and thus an ink receiving layer coating solution F was prepared.

| | | |
|---|---|---|
| polyvinyl alcohol (14% aqueous solution) | 5 | ml |
| (trade name: PVA203, manufactured by Kuraray Co., Ltd.) | | |
| polyvinyl alcohol (6.5% aqueous solution) | 240 | ml |
| (trade name: PVA245, manufactured by Kuraray Co., Ltd.) | | |
| saponin (35% aqueous solution) | 3.0 | ml |

<Preparation of Ink Receiving Layer Coating Solution G>

To 300 ml of the silica dispersion F under stirring at 40° C., the following additives were subsequently added, pure water was added to the mixture to make 1000 ml, and thus an ink receiving layer coating solution G was prepared.

| | | |
|---|---|---|
| polyvinyl alcohol (14% aqueous solution) | 5 | ml |
| trade name: PVA203, manufactured by Kuraray Co., Ltd.) | | |
| polyvinyl alcohol (6.5% aqueous solution) | 240 | ml |
| (trade name: PVA245, manufactured by Kuraray Co., Ltd.) | | |
| silicon oil dispersion | 4 | ml |
| (trade name: BY22-839, manufactured by Toray Dow | | |
| Corning Silicone Co. Ltd.) | | |
| saponin (35% aqueous solution) | 1.5 | ml |
| fluorine-based surfactant F-2 (see below) | 5 | ml |
| (4% solution containing water:isopropyl alcohol = 1:1) | | |

(Fluorine-Based Surfactant F-2)

C₈F₁₇CONH(CH₂)₃—N⁺(CH₃)₂CH₂COO⁻

<Making of Inkjet Recording Material>

To the support made in a manner substantially similar to Example 1, the ink receiving layer coating solution F as the lower layer coating solution and the ink receiving layer coating solution G as the upper layer coating solution were applied at 40° C. using a two-layer slide hopper coater such that the coating thickness of the lower layer was 150 μm and the dry thickness of the upper layer was 2.2 μm, whereby a coating layer was formed.

The coating layer was cooled at 8° C. for 20 seconds, and then dried at 20 to 30° C. for 60 seconds, at 45° C. for 60 seconds, and at 50° C. for 60 seconds, and conditioned at 23° C. and a relative humidity of 40 to 60%, whereby an inkjet recording material was made.

### Comparative Example 5

An inkjet recording material was made in a manner substantially similar to Example 3, except that, in the preparation of the ink receiving layer coating solution C, the amount of the polyvinyl alcohol (water-soluble resin) solution C was changed to 624 parts.

### Comparative Example 6

An inkjet recording material was made in a manner substantially similar to Example 1, except that, in the preparation of the ink receiving layer coating solution A, the amount of the polyvinyl alcohol (water-soluble resin) solution A was changed to 15.6 parts, and, in the preparation of the ink receiving layer coating solution B, the amount of the polyvinyl alcohol (water-soluble resin) solution B was changed to 15.6 parts.

### Comparative Example 7

An inkjet recording material was made in a manner substantially similar to Example 1, except that the coating layer was dried at 100° C. (dew point: 23° C.) in place of 90° C. until the solid content concentration of the coating layer became 17%, and dried at 60° C. (dew point: 23° C.) in place of 55° C. until the solid content concentration of the coating layer became 24%.

[Evaluation]

The inkjet recording materials obtained were subjected to the following evaluations. The evaluation results are listed in Table 1. The inkjet recording material made in Comparative Example 6 generated cracks in the ink receiving layer, so that its glossiness and ink absorbency could not evaluated.

<Glossiness>

Glossiness was measured in terms of the specular glossiness at 60° and 75° using a digital variable angle glossmeter (trade name: UGV-50DP, manufactured by Suga Test Instrument Co., Ltd.).

<Ink Absorbency>

Using an ink jet printer (trade name: PMA-820, manufactured by Seiko Epson Corporation) mounted with a genuine ink set, a black solid image was printed on the respective ink jet recording materials after conditioned for one day at 23° C., 50% RH. The presence or absence of ink bleeding was visually observed, and rated according to the following criteria.

—Evaluation Criteria—

A: No ink bleeding.

B: Slight ink bleeding, practically unacceptable.

C: Notable ink bleeding.

<Carbon/Silicon Ratio in Outermost Surface>

The arithmetic average of the carbon/silicon ratio (C/Si (surface)) in the outermost surface was measured using an X-ray photoelectron spectroscopic apparatus (XPS or ESCA). The X-ray photoelectron spectroscopic apparatus used herein was AXIS-HSi manufactured by Kratos Analytical Ltd. The inkjet recording material obtained above was cut into pieces of an appropriate size, a piece is mounted on the sample stage, and then introduced into the apparatus after preliminary evacuation. The X ray source was monochromatized AIKα rays generated at an accelerating voltage of 15 kV and 150 W, and the measured area through a magnetic lens was a circle having a diameter of about 1 mm. The C1s peak and Si2p peak were measured at a degree of vacuum of 1 to 9×10⁻⁸ torr, a take-off angle of 90° with respect to the photoelectrons generated from the sample, and a pass energy of 40 eV. With respect to the peak areas (count·eV/sec), the relative sensitivity coefficients for the elements were defined as 0.278 and 0.328 for C1s and Si2p, respectively, whereby the abundance molar ratio of C/Si was determined.

<Carbon/Silicon Mass Ratio in the Region Extending from the Outermost Surface to a Depth of 5 μm>

The arithmetic average of the carbon/silicon mass ratio (C/Si (5 μm)) in the region extending from the outermost surface to a depth of 5 μm was measured using an SEM-EDX apparatus.

The inkjet recording material obtained above was cut with a diamond knife of ULTRACUT UCT manufactured by Leica, whereby a section sample of the ink receiving layer was made. The sample was cut into an appropriate size, fixed to the sample stage, and sputter-coated with platinum in a thickness of about 3 nm.

The SEM-EDX apparatus was composed of JSM-6700 manufactured by JEOL Ltd. and Genesis manufactured by EDAX Japan K.K.

The sample was introduced to the apparatus, and the section was observed under SEM at an accelerating voltage of 20 kV and a magnification of 1500×. In the SEM image, a rectangular region defined by a depth of 5 μm from the outermost surface to a depth in the thickness direction of the ink receiving layer, and a length of 70 μm in the direction parallel to the support (5 μm×70 μm) was irradiated with an electron beam, and the X ray generated therefrom was captured and measured. During the measurement, the electron beam flow was constant, X ray was captured for 100 seconds, and the spectrum obtained was analyzed with the soft attached to the apparatus, whereby the arithmetic average of the C/Si mass ratio was determined.

TABLE 1

| | Drying | Dew | C/Si | C/Si | Glossiness | Glossiness | Ink |
|---|---|---|---|---|---|---|---|
| | temperature | point | (surface) | (5 μm) | (75° ) | (60° ) | Absorbency |
| Example 1 | 90° C. →55° C. | 5° C. | 6.7 | 2.6 | 79 | 63 | A |
| Example 2 | 105° C. →50° C. | 23° C. | 4.4 | 3.1 | 76 | 54 | A |
| Example 3 | 90° C. →55° C. | 5° C. | 2.8 | 2.4 | 68 | 45 | A |
| Comparative | 45° C. | 5° C. | 1.8 | 2.6 | 63 | 35 | A |
| Example 1 | | | | | | | |
| Comparative | 100° C. →65° C. | 23° C. | 39 | 2.5 | 95 | 76 | C |
| Example 2 | | | | | | | |
| Comparative | 45° C. | 5° C. | 1.6 | 2.7 | 62 | 35 | A |
| Example 3 | | | | | | | |
| Comparative | 45° C. | 5° C. | 1.5 | 2.4 | 61 | 34 | A |
| Example 4 | | | | | | | |
| Comparative | 90° C. →55° C. | 5° C. | 5.4 | 4.5 | 77 | 58 | C |
| Example 5 | | | | | | | |
| Comparative | 90° C. →55° C. | 5° C. | 3.5 | 1.2 | — | — | — |
| Example 6 | | | | | | | |
| Comparative | 100° C. →60° C. | 23° C. | 12 | 2.7 | 82 | 66 | B |
| Example 7 | | | | | | | |

The results listed in Table 1 indicate that the inkjet recording material of the invention exhibits high glossiness and favorable ink absorbency.

According to the invention, an inkjet recording material having high glossiness and favorable ink absorbency is provided. More specifically, the invention may provide the following items of <1> to <8>:
<1>. An inkjet recording material comprising a support having thereon an ink receiving layer containing silica fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0.
<2>. The inkjet recording material of the item <1>, wherein the water-soluble resin is polyvinyl alcohol.
<3>. The inkjet recording material of the item <1> or the item <2>, wherein the ink receiving layer further comprises a cross-linking agent.
<4>. The inkjet recording material of any one of the items <1> to <3>, wherein the ink receiving layer further comprises a water-soluble aluminum compound.
<5>. The inkjet recording material of any one of the items <1> to <4>, wherein the ink receiving layer further comprises a zirconium compound.
<6>. The inkjet recording material of any one of the items <1> to <5>, wherein the ink receiving layer further comprises an organic solvent with a high boiling point.
<7>. The inkjet recording material of the item <3>, wherein the cross-linking agent is a boron compound
<8>. The inkjet recording material of any one of the items <1> to <7>, wherein the silica fine particles are vapor-phase process silica having a specific surface area of 200 m²/g or more as determined by the BET (Brunauer, Emmett, Teller) surface area measurement method.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording material comprising a support having thereon an ink receiving layer containing silica fine particles and a water-soluble resin, the arithmetic average of the mass ratio of carbon atoms to silicon atoms contained in an outermost surface farthest from the support of the ink receiving layer being from 2.5 to 7.0, and the arithmetic average of the mass ratio of carbon atoms to silicon atoms contained in a region extending from the outermost surface to a depth of 5 μm in the thickness direction of the ink receiving layer being from 1.5 to 4.0.

2. The inkjet recording material of claim 1, wherein the water-soluble resin is polyvinyl alcohol.

3. The inkjet recording material of claim 1, wherein the ink receiving layer further comprises a cross-linking agent.

4. The inkjet recording material of claim 1, wherein the ink receiving layer further comprises a water-soluble aluminum compound.

5. The inkjet recording material of claim 1, wherein the ink receiving layer further comprises a zirconium compound.

6. The inkjet recording material of claims 1, wherein the ink receiving layer further comprises an organic solvent with a high boiling point.

7. The inkjet recording material of claim 3, wherein the cross-linking agent is a boron compound.

8. The inkjet recording material of claim 1, wherein the silica fine particles are vapor-phase process silica having a specific surface area of 200 m²/g or more as determined by the BET (Brunauer, Emmett, Teller) surface area measurement method.
